(19) United States
(12) Patent Application Publication
(10) Pub. No.: US 2010/0059248 A1
(43) Pub. Date: Mar. 11, 2010

(54) INSULATION COATING AND ELECTRIC INSULATED WIRE

(75) Inventors: Yuki HONDA, Hitachi (JP); Tomiya ABE, Hitachi (JP); Hideyuki KIKUCHI, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Cable, Ltd. & Hitachi Magnet Wire Corp.

(21) Appl. No.: 12/555,908

(22) Filed: Sep. 9, 2009

(30) Foreign Application Priority Data
Sep. 9, 2008 (JP) 2008-231180

(51) Int. Cl. H01B 3/30; C08L 79/08

(52) U.S. Cl. 174/110 SR; 524/606

(57) ABSTRACT

An electric insulated wire according to the present invention is formed by applying a first insulation coating made from polyimide resin having a repeating unit represented as in chemical formula (1) to an electric conductor directly or through an insulation layer made from a second insulation coating, after which the first insulation coating is baked, the polyimide resin including a quadrivalent aromatic group (X) having an aromatic ether structure, a bivalent aromatic group (Y₁) having an aromatic ether structure, and a bivalent aromatic group (Y₂) having a fluorene structure; the first insulation coating has a compound ratio (Y₁/Y₂) of the bivalent aromatic group having an aromatic ether structure to the bivalent aromatic group having a fluorene structure within a range from 30/70 to 80/20, when represented as a mole ratio.

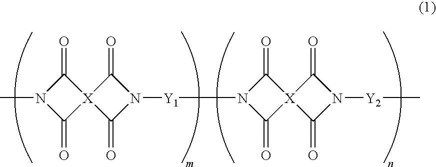

### CLAIM OF PRIORITY

The present application claims priority from Japanese patent application serial no. 2008-231180 filed on Sep. 9, 2008, the content of which is hereby incorporated by reference into this application.

### BACKGROUND OF THE INVENTION

1. Field of the Invention

The present invention relates to an insulation coating applied to an electric conductor and baked to form an insulation film as well as an electric insulated wire produced by using the insulation coating. More particularly, the present invention relates to an insulation coating made from polyimide as well as an electric insulated wire produced by using the insulation coating.

2. Description of Related Art

As for some general electric insulated wires for use as coils in motors and transformers, an insulation coating is applied to an electric conductor and is baked to form an insulation film comprising a single layer or a plurality of layers. Electric insulated wires of this type are widely used, in the form of windings for example, as coils in large-capacity, large-sized electric units or heavy electric units. When motors or transformers are manufactured for example, electric insulated wires, in general, have been mainly wound continuously in a coiled shape in the slots in the cores of the motors. In another main method, electric insulated wires have been wound in a coiled shape and then fitted to and inserted into the slots of the cores.

In a method proposed for coils used in electric units which need high-density magnetic fluxes, such as, e.g., coils used in electric generators in automobiles, short electric insulated wires having a cross sectional shape matching the shape of a coil such as, e.g., electric insulated wires with a large cross sectional area (a large outer diameter) or electric insulated wires with a rectangular electric conductor are used; the ends of an electric insulated wire are welded to the ends of the adjacent electric insulated wires to form a long coil, instead of forming a long coil with a large number of turns by continuously winding an electric insulated wire.

The main electric insulated wires used to form these coils are manufactured by applying an insulation coating made from polyester imide resin to the circumference of an electric conductor and by baking the insulation coating to form an insulation film, followed by applying another insulation coating made from polyamide-imide resin to the circumference of the insulation film of polyester imide and by baking the other insulation coating to form another insulation film. Alternatively, these electric insulated wires are manufactured just by applying an insulation coating made from polyamide-imide resin to the circumference of an electric conductor and by baking the insulation coating to form an insulation film.

Another electric insulated wire is also manufactured by applying an insulation coating made from polyimide resin to the circumference of an electric conductor and by baking the insulation coating to form an insulation film, followed by applying another insulation coating made from polyamide-imide resin to the circumference of the insulation film of polyimide and by baking the other insulation coating to form another insulation film. Since polyimide resin and polyamide-imide resin fall in a high continuous heat resistance class, i.e., a 180-220° C. class, the electric insulated wire of this type is used as an electric insulated wire having improved heat resistance and mechanical strength (see, e.g., JP-A Hei 5 (1993)-130759).

A known electric insulated wire having an insulation film formed by applying an insulation coating made from polyimide resin is manufactured by applying, to an electric conductor, an insulation coating made from polyimide resin that is formed by, for example, using a raw monomer, which comprises 4,4′ oxydiphthalic anhydride and aromatic ether diamine, to synthesize a polyimide precursor and then heating it to convert it to imide, after which the applied insulation coating is baked (see, e.g., JP-A-2001-31764).

Also known is an insulation coating made from polyimide resin the raw monomer of which comprises 4,4′ oxydiphthalic anhydride, aromatic ether diamine, and silicone diamine (see, e.g., JP-A Hei 10 (1998)-231425).

As recent electric units have been made compact and their performance has been improved, these units are being controlled by high-voltage inverters. In control of an electric unit by an inverter, a high surge voltage generated by the inverter may enter a motor and thereby the motor insulation system is affected. Although electric insulated wires having an insulation film made from polyimide resin or polyamide-imide resin are highly heat resistant, they have high dielectric constants due to their high polarity. If these electric insulated wires are used in motors, deterioration of the insulation layer is accelerated by corona discharges caused by the inverter surge voltage.

In order to prevent the insulation film from being deteriorated by this type of inverter surge voltage, it suffices that the insulation film has a higher dielectric breakdown voltage than a voltage at which a corona discharge starts to occur. That is, if the voltage at which a corona discharge starts to occur on the insulation film is raised, corona discharges are suppressed, enabling the life of the insulation film (and thereby the life of the electric insulated wire) to be prolonged.

As a method of raising the voltage at which a corona discharge starts to occur on the insulation film, the insulation film may be thickened or the dielectric constant of the insulation film may be lowered. To lower the dielectric constant of an insulation film, a method is proposed in which an insulation coating made from fluorine-based polyimide resin is applied to the surface of an electric conductor and is baked to form an insulation film (see, e.g., JP-A-2002-56720).

If, however, an insulation coating made from fluorine-based polyimide resin is used to form an insulation film on the surface of the electric conductor to raise the voltage at which a corona discharge starts to occur on the insulation film, the dielectric constant of the insulation film is lowered, but adhesion between the insulation film and electric conductor becomes inadequate, causing a float between them. When this happens, a dielectric breakdown occurs at a low voltage.

If the insulation coating, described in, e.g., JP-A-2001-31764, which is made from aromatic ether polyimide resin, is used to form an insulation film, the coefficient of elasticity of the insulation film is significantly reduced at high temperatures due to the high thermal plasticity of the insulation film, making the insulation film inferior in heat resistance due to its low softening temperature.

### SUMMARY OF THE INVENTION

Under these circumstances in order to address the above problems in the prior art, it is an objective of the present invention to provide an insulation coating from which an insulation film that is highly heat resistant, highly adhesive to an electric conductor, and superior in control of corona discharge suppression and has a low dielectric constant is obtained, and also to provide an electric insulated wire produced by using the insulation coating.

In an insulation coating which is applied to an electric conductor and is baked to form an insulation film, the insulation coating according to one aspect of the present invention comprises a polyimide resin having a repeating unit represented as in chemical formula (1) below,

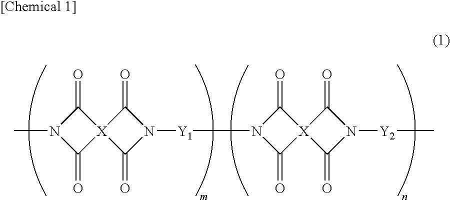

wherein: X in chemical formula (1) is a quadrivalent aromatic group having an aromatic ether structure represented as in the following chemical formula;

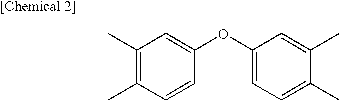

Y₁ in chemical formula (1) above is a bivalent aromatic group having an aromatic ether structure represented as in the following chemical formula;

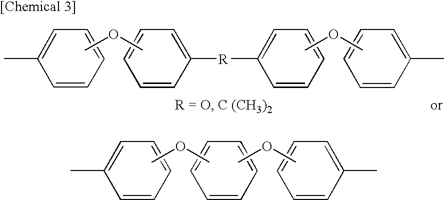

Y₂ in chemical formula (1) above is a bivalent aromatic group having a fluorene structure represented as in the following chemical formula; and

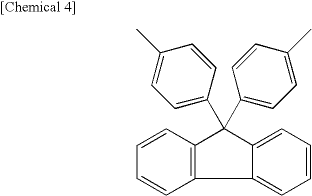

a compound ratio (Y₁/Y₂) between Y₁ and Y₂ in chemical formula (1) above is within a range from 30/70 to 80/20, when represented as a mole ratio.

In the above aspect of the present invention, the following modifications and changes can be made.

(i) In the insulation coating, a ratio (m/n) between m and n in chemical formula (1) above is not smaller than 0.4 but not greater than 4.0.

(ii) Bivalent aromatic group Y₁ having an aromatic ether structure is one of 2,2-bis [4-(amino phenoxy)phenyl]propane, 1,3-bis (4-amino phenoxy)benzene, and 1,4-bis (4-amino phenoxy)benzene, and bivalent aromatic group Y₂ having a fluorene structure is 9,9-bis-4-(aminophenyl)fluorene.

(iii) An electric insulated wire has an insulation film formed by applying the insulation coating described above to an electric conductor directly or through an internal insulation film and then by baking the insulation coating.

(iv) The internal insulation film is formed by applying a silane coupling agent to the electric conductor and then by baking the silane coupling agent.

### ADVANTAGES OF THE INVENTION

The present invention can provide an insulation coating from which an insulation film that is highly heat resistant, highly adhesive to an electric conductor, and superior in control of corona discharge suppression and has a low dielectric constant. The present invention also can provide an electric insulated wire produced by using the insulation coating.

### DETAILED DESCRIPTION OF THE PREFERRED EMBODIMENT

The inventors of the present invention carried out a diligent study in order to obtain an electric insulated wire which is highly heat resistant, highly adhesive to an electric conductor, and superior in control of corona discharge suppression and has a low dielectric constant, and thereby is preferable particularly for use as coils in motors and transformers. The inventors found that such an electric insulated wire can be achieved by applying a first insulation coating made from polyimide resin to an electric conductor directly or through an insulation layer made from a second insulation coating, after which the first insulation coating is baked, the polyimide resin including a quadrivalent aromatic group having an aromatic ether structure, a bivalent aromatic group having an aromatic ether structure, and a bivalent aromatic group having a fluorine structure; the first insulation coating has a compound ratio of the bivalent aromatic group having an aromatic ether structure to the bivalent aromatic group having a fluorene structure within a range from 30/70 to 80/20, when represented as a mole ratio. This led to the present invention.

A preferred embodiment of the present invention will be described in detail below. However, the present invention is not limited to the embodiments described herein.

(Insulation Coating)

At first, an insulation coating according to this embodiment will be described. When the insulation coating according to this embodiment is applied to an electric conductor and baked, the insulation coating forms an insulation film. The insulation coating is made from polyimide resin having a repeating unit represented as in chemical formula (1) below;

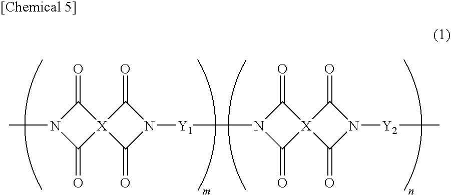

X in chemical formula (1) is a quadrivalent aromatic group having an aromatic ether structure represented as in the following chemical formula;

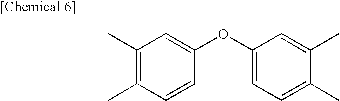

Y₁ is a bivalent aromatic group having an aromatic ether structure represented as in the following chemical formula;

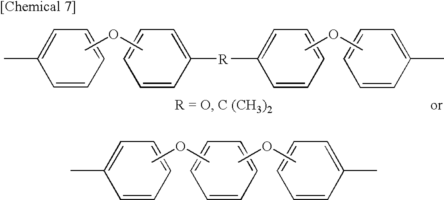

Y₂ is a bivalent aromatic group having a fluorene structure represented as in the following chemical formula.

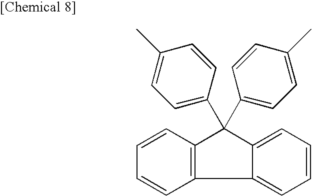

An example of quadrivalent aromatic group X having an aromatic ether structure may be 4,4′ oxydiphthalic anhydride (ODPA). Examples of bivalent aromatic group Y₁ having an aromatic ether structure may include 2,2-bis [4-(amino phenoxy)phenyl]propane (BAPP), 1,3-bis (4-amino phenoxy)benzene (TPE-R), and 1,4-bis (4-amino phenoxy)benzene (TPE-Q). An example of bivalent aromatic group Y₂ having a fluorene structure may be 9,9-bis-4-(aminophenyl)fluorene (FDA).

A ratio (m/n) between m and n in chemical formula (1) described above (m and n are variables) is preferably not smaller than 0.4 but not greater than 4.0. If m/n is smaller than 0.4, the fluorene structure, which becomes a rigid component, is increased, reducing the flexibility of the main chain of polyimide. Accordingly, durability against 180-degree folding (flexibility) is significantly reduced. If m/n is greater than 4.0, the aromatic ether structure is increased, lowering the glass transition temperature and thereby allowing thermal plasticity to be likely to occur. Although the insulation film is not deteriorated by heat, the insulation film is softened and deformed in a low-temperature range. Then, the insulation film may not exhibit resistance to deformation by heat, which is its inherent characteristic.

The compound ratio (Y₁/Y₂) between Y₁, which is a bivalent aromatic group having an aromatic ether structure, and Y₂, which is a bivalent aromatic group having a fluorene structure, in chemical formula (1) above is preferably within a range from 30/70 to 80/20, when represented as a mole ratio. If this compound ratio (Y₁/Y₂) is less than 30/70, when represented as a mole ratio, the fluorene structure, which becomes a rigid component, is increased, reducing the flexibility of the main chain of polyimide. Accordingly, durability against 180-degree folding (flexibility) is reduced. If the compound ratio exceeds 80/20, the aromatic ether structure is increased, lowering the glass transition temperature and thereby allowing thermal plasticity to be likely to occur. The resistance of the insulation film to deformation by heat is lowered. The insulation film may start to soften and deform in a low-temperature range, for example.

The insulation coating according to the present invention comprises the resins described above and a solvent, the insulation coating being synthesized in the solvent. Examples of the solvent include N-methyl-pyrrolidone (NMP), dimethyl formaldehyde, dimethylacetamide, sulfolane, anisole, dioxolane, butylcellosolve acetate, and lactone solvents. These solvents may be used alone, or two or more of them may be combined. After the above resins are solved in a solvent, the resulting solution is stirred with a stirrer or the like for a prescribed duration (for five hours, for example) at room temperature, and then a chemical reaction is caused, being obtained the novel insulation coating made from polyimide.

To further improve adhesion with the electric conductor as necessary, a silane coupling agent may be added to the resin coating. Although there are no restrictions on the silane coupling agent, preferable examples include:
3-glycidoxypropyl trimethoxysilane,
3-methacryloxy propyltrimethoxysilane,
3-acryloxy propyltrimethoxysilane,
3-aminopropyl-trimethoxysilane,
3-aminopropyl-triethoxysilane,
N-2-(aminoethyl)-3-aminopropyl-trimethoxysilane, and
3-mercaptopropyl-trimethoxysilane.

(Electric Insulated Wire)

Next, an electric insulated wire produced by using the insulation coating according to this embodiment will be described.

The electric insulated wire according to this embodiment comprises an electric conductor and an insulation film formed by applying the insulation coating described above to the electric conductor directly or through another insulation layer and then by baking the insulation coating. The electric conductor is formed from, e.g., an annealed copper wire. The electric conductor may have a large cross sectional area (a large outer diameter) or may have a cross section matching the shape of a coil, such as a rectangular cross sectional shape.

In this embodiment, an internal insulation film may be formed around the inner circumference of the insulation film (around the outer circumference of the electric conductor) by using a silane coupling agent, in order to improve the adhesion between the electric conductor and insulation film. In order to improve resistance to scratches, an external insulation film having lubricant characteristics may be formed as the outermost layer (on the outer circumference of the insulation film). The external insulation film may be formed from, e.g., polyamide-imide resin.

To manufacture the electric insulated wire according to this embodiment, a silane coupling agent is first applied to the outer circumference of the electric conductor, after which the silane coupling agent is heated in a furnace or the like to form an inner insulation film. Then, an insulation coating is applied to the outer circumference of the inner insulation film by using a die, after which the insulation coating is baked in a furnace or the like, producing the electric insulated wire according to this embodiment.

An effect of this embodiment will be described. As mentioned before, the insulation coating is made from polyimide resin having a repeating unit represented as in chemical formula (1) below;

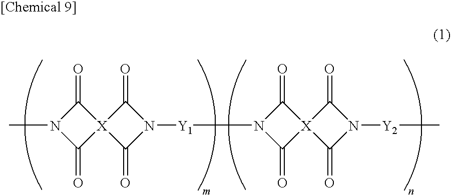

X in chemical formula (1) is a quadrivalent aromatic group having an aromatic ether structure represented as in the following chemical formula;

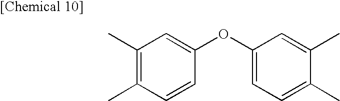

Y₁ in general chemical formula (1) is a bivalent aromatic group having an aromatic ether structure represented as in the following chemical formula;

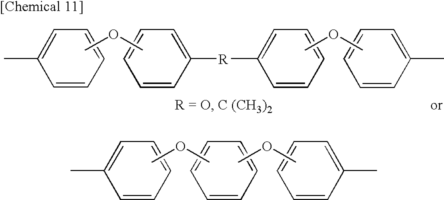

Y₂ in general chemical formula (1) is a bivalent aromatic group having a fluorene structure represented as in the following chemical formula.

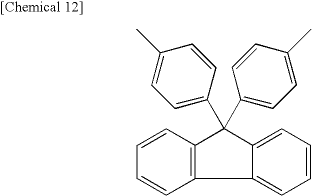

A compound ratio (Y₁/Y₂) between Y₁ and Y₂ in chemical formula (1) above is within a range from 30/70 to 80/20, when represented as a mole ratio.

When polyimide resin having this type of structure is used, the imide concentration can be lowered without lowering the glass transition temperature and adhesion to copper, so a low dielectric constant can be achieved without sacrificing the heat resistance (resistance to deformation due to heat) of the insulation film and high adhesion to the electric conductor. Accordingly, when the novel insulation coating is applied to an electric conductor and is baked to form an insulation film, an electric insulated wire superior in heat resistance, adhesion between the electric conductor and insulation film, corona suppression, and dielectric breakdown characteristics can be obtained.

With the insulation coating according to this embodiment, the ratio m/n between m and n in general chemical formula (1) is not smaller than 0.4 but not greater than 4.0, enabling flexibility (durability against 180-degree folding), resistance to deterioration due to heat, and resistance to deformation due to heat to be improved. Accordingly, when the novel insulation coating is applied to an electric conductor and is baked to form an insulation film, an electric insulated wire with excellent characteristics can be obtained in which the electric insulated wire has high flexibility (durability against 180-degree folding), high heat resistance, high adhesion to the electric conductor, a low dielectric constant, a high dielectric breakdown voltage, and superior performance in appearance after application of 500 kV/mm, and is suitable for use as a coil, particularly in a motor, a transformer, etc.

In addition, the electric insulated wire according to this embodiment has an inner insulation film around the inner circumference of the insulation film by using a silane coupling agent, further improving the adhesion between the electric conductor and insulation film.

### EXAMPLES

Specific examples of the present invention will be described below. However, the present invention is not limited to the specific examples described herein.

### Preparation of Example 1

A condenser tube with a ball, which has a trap with a silicone cock, was attached to a 5-liter separable three-neck flask to which a stirrer is attached. Then, reactants: 310.0 grams of 4,4′ oxydiphthalic anhydride (ODPA) with a molecular weight of 310.21; 205.3 grams of 2,2-bis [4-(amino phenoxy)phenyl]propane (BAPP) with a molecular weight of 410.5; and 174.3 grams of 9,9-bis-4-(aminophenyl)fluorene (FDA) with a molecular weight of 348.44, and 2759 grams of N-methyle-2-pyrrolidone, which was used as a solvent, were supplied into the three-neck flask, after which the mixture underwent a chemical reaction for five hours at room temperature.

Rotation rate of the stirrer was initially set at 250 rpm. The rotation rate was appropriately decreased with proceeding the chemical reaction (with decreasing the reactants) to obtain an insulation coating made from polyimide resin. A 1% solution of 3-aminopropyltrimethoxysilane (KBE-903 from Shin-Etsu Chemical Co., Ltd.) was applied to a copper conductor with a round transection. The copper conductor was heated in a far-infrared furnace at 100° C. for five minutes to obtain a 1-μm inner insulation film. The above-mentioned insulation coating made from polyimide resin was applied around the inner insulation film through a coating die, and was baked at 240° C. for one minute and then at 340° C. for one minute to cover the inner insulation film with another insulation film. This process was repeated 14 times to manufacture an electric insulated wire with a 31-μm-thick sheath.

### Preparation of Example 2

A condenser tube with a ball, which has a trap with a silicone cock, was attached to a 5-liter separable three-neck flask to which a stirrer is attached. Then, reactants: 310.0 grams of 4,4′ oxydiphthalic anhydride (ODPA) with a molecular weight of 310.21; 146.2 grams of 1,3-bis [4-(amino phenoxy)phenyl]benzene (TPE-R) with a molecular weight of 292.3; and 174.3 grams of 9,9-bis-4-(aminophenyl)fluorene (FDA) with a molecular weight of 348.44, and 2523 grams of N-methyle-2-pyrrolidone, which was used as a solvent, were supplied into the three-neck flask, after which the mixture underwent a chemical reaction for five hours at room temperature.

Rotation rate of the stirrer was initially set at 250 rpm. The rotational rate was appropriately decreased with proceeding the chemical reaction (with decreasing the reactants) to obtain an insulation coating made from polyimide resin. A 1% solution of 3-aminopropyltrimethoxysilane (KBE-903 from Shin-Etsu Chemical Co., Ltd.) was applied to a copper conductor with a round transection. The copper conductor was heated in a far-infrared furnace at 100° C. for five minutes to obtain a 1-μm inner insulation film. The above-mentioned insulation coating made from polyimide resin was applied around the inner insulation film through a coating die, and was baked at 240° C. for one minute and then at 340° C. for one minute to cover the inner insulation film with another insulation film. This process was repeated 14 times to manufacture an electric insulated wire with a 31-μm-thick sheath.

### Preparation of Example 3

A condenser tube with a ball, which has a trap with a silicone cock, was attached to a 5-liter separable three-neck flask to which a stirrer is attached. Then, reactants: 310.0 grams of 4,4′ oxydiphthalic anhydride (ODPA) with a molecular weight of 310.21; 146.2 grams of 1,4-bis [4-(amino phenoxy)phenyl]benzene (TPE-Q) with a molecular weight of 292.3; and 174.3 grams of 9,9-bis-4-(aminophenyl)fluorene (FDA) with a molecular weight of 348.44, and 2523 grams of N-methyle-2-pyrrolidone, which was used as a solvent, were supplied into the three-neck flask, after which the mixture underwent a chemical reaction for five hours at room temperature.

Rotation rate of the stirrer was initially set at 250 rpm. The rotational rate was appropriately decreased as with proceeding the chemical reaction (with decreasing the reactants) to obtain an insulation coating made from polyimide resin. A 1% solution of 3-aminopropyltrimethoxysilane (KBE-903 from Shin-Etsu Chemical Co., Ltd.) was applied to a copper conductor with a round transection. The copper conductor was heated in a far-infrared furnace at 100° C. for five minutes to obtain a 1-μm inner insulation film. The above-mentioned insulation coating made from polyimide resin was applied around the inner insulation film through a coating die, and was baked at 240° C. for one minute and then at 340° C. for one minute to cover the inner insulation film with another insulation film. This process was repeated 14 times to manufacture an electric insulated wire with a 31-μm-thick sheath.

### Preparation of Example 4

A condenser tube with a ball, which has a trap with a silicone cock, was attached to a 5-liter separable three-neck flask to which a stirrer is attached. Then, reactants: 310.0 grams of 4,4′ oxydiphthalic anhydride (ODPA) with a molecular weight of 310.21; 123.2 grams of 2,2-bis [4-(amino phenoxy)phenyl]propane (BAPP) with a molecular weight of 410.5; and 243.9 grams of 9,9-bis-4-(aminophenyl)fluorene (FDA) with a molecular weight of 348.44, and 2708 grams of N-methyle-2-pyrrolidone, which was used as a solvent, were supplied into the three-neck flask, after which the mixture underwent a chemical reaction for five hours at room temperature.

Rotation rate of the stirrer was initially set at 250 rpm. The rotational rate was appropriately decreased with proceeding the chemical reaction (with decreasing the reactants) to obtain an insulation coating made from polyimide resin. A 1% solution of 3-aminopropyltrimethoxysilane (KBE-903 from Shin-Etsu Chemical Co., Ltd.) was applied to a copper conductor with a round transection. The copper conductor was heated in a far-infrared furnace at 100° C. for five minutes to obtain a 1-μm inner insulation film. The above-mentioned insulation coating made from polyimide resin was applied around the inner insulation film through a coating die, and was baked at 240° C. for one minute and then at 340° C. for one minute to cover the inner insulation film with another insulation film. This process was repeated 14 times to manufacture an electric insulated wire with a 31-μm-thick sheath.

### Preparation of Example 5

A condenser tube with a ball, which has a trap with a silicone cock, was attached to a 5-liter separable three-neck flask to which a stirrer is attached. Then, reactants: 310.0 grams of 4,4′ oxydiphthalic anhydride (ODPA) with a molecular weight of 310.21; 328.4 grams of 2,2-bis [4-(amino phenoxy)phenyl]propane (BAPP) with a molecular weight of 410.5; and 69.7 grams of 9,9-bis-4-(aminophenyl)fluorene (FDA) with a molecular weight of 348.44, and 2832 grams of N-methyle-2-pyrrolidone, which was used as a solvent, were supplied into the three-neck flask, after which the mixture underwent a chemical reaction for five hours at room temperature.

Rotation rate of the stirrer was initially set at 250 rpm. The rotational rate was appropriately decreased with proceeding the chemical reaction (with decreasing the reactants) to obtain an insulation coating made from polyimide resin. A 1% solution of 3-aminopropyltrimethoxysilane (KBE-903 from Shin-Etsu Chemical Co., Ltd.) was applied to a copper conductor with a round transection. The copper conductor was heated in a far-infrared furnace at 100° C. for five minutes to obtain a 1-μm inner insulation film. The above-mentioned insulation coating made from polyimide resin was applied around the inner insulation film through a coating die, and was baked at 240° C. for one minute and then at 340° C. for one minute to cover the inner insulation film with another insulation film. This process was repeated 14 times to manufacture an electric insulated wire with a 31-μm-thick sheath.

### Preparation of Comparative Example 1

A condenser tube with a ball, which has a trap with a silicone cock, was attached to a 5-liter separable three-neck flask to which a stirrer is attached. Then, reactants: 310.0 grams of 4,4′ oxydiphthalic anhydride (ODPA) with a molecular weight of 310.21; and 348.5 grams of 9,9-bis-4-(aminophenyl)fluorene (FDA) with a molecular weight of 348.44, and 2634 grams of N-methyle-2-pyrrolidone, which was used as a solvent, were supplied into the three-neck flask, after which the mixture underwent a chemical reaction for five hours at room temperature.

Rotation rate of the stirrer was initially set at 250 rpm. The rotational rate was appropriately decreased with proceeding the chemical reaction (with decreasing the reactants) to obtain an insulation coating made from polyimide resin. A 1% solution of 3-aminopropyltrimethoxysilane (KBE-903 from Shin-Etsu Chemical Co., Ltd.) was applied to a copper conductor with a round transection. The copper conductor was heated in a far-infrared furnace at 100° C. for five minutes to obtain a 1-μm inner insulation film. The above-mentioned insulation coating made from polyimide resin was applied around the inner insulation film through a coating die, and was baked at 240° C. for one minute and then at 340° C. for one minute to cover the inner insulation film with another insulation film. This process was repeated 14 times to manufacture an electric insulated wire with a 31-μm-thick sheath.

### Preparation of Comparative Example 2

A condenser tube with a ball, which has a trap with a silicone cock, was attached to a 5-liter separable three-neck flask to which a stirrer is attached. Then, reactants: 310.0 grams of 4,4′ oxydiphthalic anhydride (ODPA) with a molecular weight of 310.21; and 410.5 grams of 2,2-bis [4-(amino phenoxy)phenyl]propane (BAPP) with a molecular weight of 410.5, and 2882 grams of N-methyle-2-pyrrolidone, which was used as a solvent, were supplied into the three-neck flask, after which the mixture underwent a chemical reaction for five hours at room temperature.

Rotation rate of the stirrer was initially set at 250 rpm. The rotational rate was appropriately decreased with proceeding the chemical reaction (with decreasing the reactants) to obtain an insulation coating made from polyimide resin. A 1% solution of 3-aminopropyltrimethoxysilane (KBE-903 from Shin-Etsu Chemical Co., Ltd.) was applied to a copper conductor with a round transection. The copper conductor was heated in a far-infrared furnace at 100° C. for five minutes to obtain a 1-μm inner insulation film. The above-mentioned insulation coating made from polyimide resin was applied around the inner insulation film through a coating die, and was baked at 240° C. for one minute and then at 340° C. for one minute to cover the inner insulation film with another insulation film. This process was repeated 14 times to manufacture an electric insulated wire with a 31-μm-thick sheath.

### Preparation of Comparative Example 3

A condenser tube with a ball, which has a trap with a silicone cock, was attached to a 5-liter separable three-neck flask to which a stirrer is attached. Then, reactants: 310.0 grams of 4,4′ oxydiphthalic anhydride (ODPA) with a molecular weight of 310.21; 369.5 grams of 2,2-bis [4-(amino phenoxy)phenyl]propane (BAPP) with a molecular weight of 410.5; and 34.8 grams of 9,9-bis-4-(aminophenyl)fluorene (FDA) with a molecular weight of 348.44, and 2817 grams of N-methyle-2-pyrrolidone, which was used as a solvent, were supplied into the three-neck flask, after which the mixture underwent a chemical reaction for five hours at room temperature.

Rotation rate of the stirrer was initially set at 250 rpm. The rotational rate was appropriately decreased with proceeding the chemical reaction (with decreasing the reactants) to obtain an insulation coating made from polyimide resin. A 1% solution of 3-aminopropyltrimethoxysilane (KBE-903 from Shin-Etsu Chemical Co., Ltd.) was applied to a copper conductor with a round transection. The copper conductor was heated in a far-infrared furnace at 100° C. for five minutes to obtain a 1-μm inner insulation film. The above-mentioned insulation coating made from polyimide resin was applied around the inner insulation film through a coating die, and was baked at 240° C. for one minute and then at 340° C. for one minute to cover the inner insulation film with another insulation film. This process was repeated 14 times to manufacture an electric insulated wire with a 31-μm-thick sheath.

### Preparation of Comparative Example 4

A condenser tube with a ball, which has a trap with a silicon cock, was attached to a 5-liter separable three-neck flask to which a stirrer is attached. Then, reactants: 310.0 grams of 4,4′ oxydiphthalic anhydride (ODPA) with a molecular weight of 310.21; 82.1 grams of 2,2-bis [4-(amino phenoxy)phenyl]propane (BAPP) with a molecular weight of 410.5; and 278.8 grams of 9,9-bis-4-(aminophenyl)fluorene (FDA) with a molecular weight of 348.44, and 2684 grams of N-methyle-2-pyrrolidone, which was used as a solvent, were supplied into the three-neck flask, after which the mixture underwent a chemical reaction for five hours at room temperature.

Rotation rate of the stirrer was initially set at 250 rpm. The rotational rate was appropriately decreased with proceeding the chemical reaction (with decreasing the reactants) to obtain an insulation coating made from polyimide resin. A 1% solution of 3-aminopropyltrimethoxysilane (KBE-903 from Shin-Etsu Chemical Co., Ltd.) was applied to a copper conductor with a round transection. The copper conductor was heated in a far-infrared furnace at 100° C. for five minutes to obtain a 1-μm inner insulation film. The above-mentioned insulation coating made from polyimide resin was applied around the inner insulation film through a coating die, and was baked at 240° C. for one minute and then at 340° C. for one minute to cover the inner insulation film with another insulation film. This process was repeated 14 times to manufacture an electric insulated wire with a 31-μm-thick sheath.

### Preparation of Comparative Example 5

A condenser tube with a ball, which has a trap with a silicone cock, was attached to a 5-liter separable three-neck flask to which a stirrer is attached. Then, reactants: 310.0 grams of 4,4′ oxydiphthalic anhydride (ODPA) with a molecular weight of 310.21; 54.7 grams of 1,4-diaminobenzene (PPD) with a molecular weight of 108.14; and 174.3 grams of 9,9-bis-4-(aminophenyl)fluorene (FDA) with a molecular weight of 348.44, and 2156 grams of N-methyle-2-pyrrolidone, which was used as a solvent, were supplied into the three-neck flask, after which the mixture underwent a chemical reaction for five hours at room temperature.

Rotation rate of the stirrer was initially set at 250 rpm. The rotational rate was appropriately decreased with proceeding the chemical reaction (with decreasing the reactants) to obtain an insulation coating made from polyimide resin. A 1% solution of 3-aminopropyltrimethoxysilane (KBE-903 from Shin-Etsu Chemical Co., Ltd.) was applied to a copper conductor with a round transection. The copper conductor was heated in a far-infrared furnace at 100° C. for five minutes to obtain a 1-μm inner insulation film. The above-mentioned insulation coating made from polyimide resin was applied around the inner insulation film through a coating die, and was baked at 240° C. for one minute and then at 340° C. for one minute to cover the inner insulation film with another insulation film. This process was repeated 14 times to manufacture an electric insulated wire with a 31-μm-thick sheath.

### Preparation of Comparative Example 6

A condenser tube with a ball, which has a trap with a silicone cock, was attached to a 5-liter separable three-neck flask to which a stirrer is attached. Then, reactants: 310.0 grams of 4,4′ oxydiphthalic anhydride (ODPA) with a molecular weight of 310.21; 263.1 grams of 1,3-bis [4-(amino phenoxy)phenyl]benzene (TPE-R) with a molecular weight of 292.3; and 34.8 grams of 9,9-bis-4-(aminophenyl)fluorene (FDA) with a molecular weight of 348.44, and 2432 grams of N-methyle-2-pyrrolidone, which was used as a solvent, were supplied into the three-neck flask, after which the mixture underwent a chemical reaction for five hours at room temperature.

Rotation rate of the stirrer was initially set at 250 rpm. The rotational rate was appropriately decreased with proceeding the chemical reaction (with decreasing the reactants) to obtain an insulation coating made from polyimide resin. A 1% solution of 3-aminopropyltrimethoxysilane (KBE-903 from Shin-Etsu Chemical Co., Ltd.) was applied to a copper conductor with a round transection. The copper conductor was heated in a far-infrared furnace at 100° C. for five minutes to obtain a 1-μm inner insulation film. The above-mentioned insulation coating made from polyimide resin was applied around the inner insulation film through a coating die, and was baked at 240° C. for one minute and then at 340° C. for one minute to cover the inner insulation film with another insulation film. This process was repeated 14 times to manufacture an electric insulated wire with a 31-μm-thick sheath.

### Preparation of Comparative Example 7

A condenser tube with a ball, which has a trap with a silicone cock, was attached to a 5-liter separable three-neck flask to which a stirrer is attached. Then, reactants: 310.0 grams of 4,4′ oxydiphthalic anhydride (ODPA) with a molecular weight of 310.21; 263.1 grams of 1,4-bis [4-(amino phenoxy)phenyl]benzene (TPE-Q) with a molecular weight of 292.3; and 34.8 grams of 9,9-bis-4-(aminophenyl)fluorene (FDA) with a molecular weight of 348.44, and 2432 grams of N-methyle-2-pyrrolidone, which was used as a solvent, were supplied into the three-neck flask, after which the mixture underwent a chemical reaction for five hours at room temperature.

Rotation rate of the stirrer was initially set at 250 rpm. The rotational rate was appropriately decreased with proceeding the chemical reaction (with decreasing the reactants) to obtain an insulation coating made from polyimide resin. A 1% solution of 3-aminopropyltrimethoxysilane (KBE-903 from Shin-Etsu Chemical Co., Ltd.) was applied to a copper conductor with a round transection. The copper conductor was heated in a far-infrared furnace at 100° C. for five minutes to obtain a 1-μm inner insulation film. The above-mentioned insulation coating made from polyimide resin was applied around the inner insulation film through a coating die, and was baked at 240° C. for one minute and then at 340° C. for one minute to cover the inner insulation film with another insulation film. This process was repeated 14 times to manufacture an electric insulated wire with a 31-μm-thick sheath.

(Measurements and Evaluations)

The insulation coatings and electric insulated wires in the above Examples 1 to 5 and Comparative examples 1 to 7 were measured and evaluated as described below.

(1) Flexibility:

A test strip formed in a film shape (25 micron thickness) was prepared from the obtained insulation coating and was cut into a size of 2 mm by 100 mm. The test strip was repeatedly bent through 180 degrees 10 times, after which the test strip was checked for cracks. When no cracks were observed, symbol “◯” was denoted in Tables 1 and 2 (in Examples 1 to 5, Comparative examples 2, 3, 6 and 7, shown later). When cracks were observed after the test, symbol “x” was given in Table 2 (in Comparative examples 1, 4 and 5, shown later).

(2) Glass Transition Temperature:

A test film (25 micron thickness) was prepared from the obtained insulation coating and was cut into a size of 30 mm by 5 mm. The dynamic viscoelastic analyzer DVA-200 from IT Measurement Control Co., Ltd. was used to measure the elastic modulus of the test film at a frequency of 10 Hz, at a temperature rise rate of 3° C./min, in a temperature range from room temperature to 400° C. The inflection point of the elastic modulus was defined as the glass transition temperature.

(3) 5% Weight Reduction Temperature:

A test film with a weight of 10 mg was prepared from the obtained insulation coating. The test film was placed in a sample pan. The thermo-gravimetric/differential thermal analyzer TG/DTA 320 from Seiko Instruments Inc. was used to thermally analyze the test film in the air, at a flow rate of 100 ml/min, at a temperature rise rate of 10° C./min, in a temperature range from room temperature to 800° C. A temperature at which the test film weight was reduced by 5% was defined as the 5% weight reduction temperature.

(4) Copper Adhesion Force:

The obtained insulation coating was applied to a copper substrate prepared for adhesion force evaluation and the applied coating was baked. The adhesion of a test strip with a width of 10 mm was evaluated by measuring its tensile strength with a universal material testing instrument (Tensilon type). Here, the copper adhesion force test was not conducted for Comparative examples 1, 4 and 5 in which cracks were observed by the flexibility test, thereby symbol “-” being denoted in Table 2 (shown later).

(5) Dielectric Constant:

A test strip formed in a film shape (25 micron thickness) was prepared from the obtained insulation coating and was cut into a size of 2 mm by 100 mm. The dielectric constant of the test strip was measured at 10 GHz by the cavity resonator perturbation method using S-parameter network analyzer 8720ES from Agilent Technologies Japan, Ltd.

(6) Dielectric Breakdown Voltage:

An insulation film was caught between brass disk electrodes with a diameter of 30 mm, which were disposed in parallel. A voltage of 1 kV was applied across the electrodes and then it was raised at a rate of 0.5 kV/min to measure the voltage at which a dielectric breakdown occurred. Here, the dielectric breakdown voltage test was not conducted for Comparative examples 1, 4 and 5 in which cracks were observed by the flexibility test, thereby symbol “-” being denoted in Table 2 (shown later).

(7) Appearance after Application of 500 kV/mm:

The obtained electric insulated wire (the insulating film of which was 31 μm thick) was caught between brass disk electrodes with a diameter of 30 mm, which were disposed in parallel. A voltage of 1 kV was applied across the electrodes and then it was raised up to 15.5 kV at a rate of 0.5 kV/min. The appearance of the insulation film of electric insulated wire was checked for cracks by a scanning electron microscopy. When no cracks were observed, symbol “◯” was denoted in Table 1 (shown later). Here, this test (application of 500 kV/mm) was not conducted for Comparative examples 1, 4 and 5 in which cracks were observed by the flexibility test. Also, for Comparative examples 2, 3, 6 and 7, this test (application of 500 kV/mm) was not conducted because a dielectric breakdown occurred below 500 kV/mm by the dielectric breakdown voltage test. Therefore, symbol “-” was denoted in Table 2 (shown later).

Table 1 shows the evaluation results of the insulation coatings and electric insulated wires in Examples 1 to 5, and Table 2 shows the evaluation results of the insulation coatings and electric insulated wires in Comparative examples 1 to 7.

TABLE 1
(Compound ratio of raw material is represented as mole ratio)

| Item | | Example 1 | Example 2 | Example 3 | Example 4 | Example 5 |
|---|---|---|---|---|---|---|
| Raw material | ODPA | 100 | 100 | 100 | 100 | 100 |
| | BAPP | 50 | 0 | 0 | 30 | 80 |
| | TPE-R | 0 | 50 | 0 | 0 | 0 |
| | TPE-Q | 0 | 0 | 50 | 0 | 0 |
| | FDA | 50 | 50 | 50 | 70 | 20 |

| | | | | | | |
|---|---|---|---|---|---|---|
| (1) | Flexibility | ◯ | ◯ | ◯ | ◯ | ◯ |
| | (durability against 180- | | | | | |
| | degree folding) | | | | | |
| (2) | Glass transition | 290 | 275 | 302 | 301 | 265 |
| | temperature (° C.) | | | | | |
| (3) | 5% weight reduction | 482 | 511 | 513 | 508 | 470 |
| | temperature (° C.) | | | | | |
| (4) | Copper adhesion force | 2.5 | 2.4 | 2.4 | 2.5 | 2.5 |
| | (N/cm) | | | | | |
| (5) | Dielectric constant | 2.7 | 2.7 | 2.7 | 2.8 | 2.8 |
| (6) | Dielectric breakdown | 584 | 576 | 563 | 565 | 542 |
| | voltage (kV/mm) | | | | | |
| (7) | Appearance after | ◯ | ◯ | ◯ | ◯ | ◯ |
| | application of 500 kV/mm | | | | | |

ODPA: 4,4′ oxydiphthalic anhydride
BAPP: 2,2-bis [4-(amino phenoxy)phenyl]propane
TPE-R: 1,3-bis (4-amino phenoxy)benzene
TPE-Q: 1,4-bis (4-amino phenoxy)benzene
FDA: 9,9-bis-4-(aminophenyl)fluorene

TABLE 2
(Compound ratio of raw material is represented as mole ratio)

| | | Comparative | Comparative | Comparative | Comparative | Comparative | Comparative | Comparative |
|---|---|---|---|---|---|---|---|---|
| Item | | example 1 | example 2 | example 3 | example 4 | example 5 | example 6 | example 7 |
| Raw | ODPA | 100 | 100 | 100 | 100 | 100 | 100 | 100 |
| material | BAPP | 0 | 100 | 90 | 20 | 0 | 0 | 0 |
| | TPE-R | 0 | 0 | 0 | 0 | 0 | 90 | 0 |
| | TPE-Q | 0 | 0 | 0 | 0 | 0 | 0 | 90 |
| | FDA | 100 | 0 | 10 | 80 | 50 | 10 | 10 |
| | PPD | 0 | 0 | 0 | 0 | 50 | 0 | 0 |

| | | | | | | | | |
|---|---|---|---|---|---|---|---|---|
| (1) | Flexibility | X | ◯ | ◯ | X | X | ◯ | ◯ |
| | (durability against | (Cracks) | | | (Cracks) | (Cracks) | | |
| | 180-degree folding) | | | | | | | |
| (2) | Glass transition | 310 | 232 | 239 | 303 | 288 | 218 | 243 |
| | temperature (° C.) | | | | | | | |
| (3) | 5% weight | 511 | 466 | 470 | 512 | 468 | 522 | 526 |
| | reduction | | | | | | | |
| | temperature (° C.) | | | | | | | |
| (4) | Copper adhesion | — | 2.5 | 2.4 | — | — | 2.5 | 2.2 |
| | force (N/cm) | | | | | | | |
| (5) | Dielectric | 2.8 | 2.8 | 2.8 | 2.8 | 3.2 | 2.9 | 2.9 |
| | constant | | | | | | | |
| (6) | Dielectric | — | 485 | 498 | — | — | 488 | 483 |
| | breakdown voltage | | | | | | | |
| | (kV/mm) | | | | | | | |
| (7) | Appearance after | — | — | — | — | — | — | — |
| | application of 500 kV/mm | | | | | | | |

ODPA: 4,4′ oxydiphthalic anhydride
BAPP: 2,2-bis [4-(amino phenoxy)phenyl]propane
TPE-R: 1,3-bis (4-amino phenoxy)benzene
TPE-Q: 1,4-bis (4-amino phenoxy)benzene
FDA: 9,9-bis-4-(aminophenyl)fluorene
PPD: 1,4-diaminobenzene

As shown in Table 1, the electric insulated wires in Examples 1 to 5, which were prepared by using the insulation coating according to the present invention, have heat resistances equivalent to the heat resistances of electric insulated wires having conventional polyimide insulation films, and the insulation films of the electric insulated wires in these Examples have dielectric coefficients of 2.8 or lower, which is lower than those of the conventional polyimide insulation films. Examples 1 to 5 are also superior in flexibility, adhesion to conductors, and the dielectric breakdown voltage.

By comparison, as shown in Table 2, flexibility in Comparative example 1, in which bivalent aromatic group Y₁ having an aromatic ether structure is not included, is low, and the dielectric breakdown voltage in Comparative example 2, in which bivalent aromatic group Y₂ having a fluorene structure is not included, is low. In Comparative examples 3, 6, and 7, in which the compound ratio of bivalent aromatic group Y₁ having an aromatic ether structure to bivalent aromatic group Y₂ having a fluorene structure exceeds 80/20, when represented as a mole ratio, the dielectric breakdown voltage is low. In Comparative example 4, in which the compound ratio is less than 30/70, flexibility is low. In Comparative example 5, in which PPD lacking an aromatic ether structure was used instead of bivalent aromatic group Y₁ having an aromatic ether structure, flexibility is low.

It is confirmed from the above experimental results that the present invention can provide an insulation film superior in heat resistance and adhesion to a conductor, has a low dielectric coefficient. Accordingly, the novel insulation coating of the present invention can be used to provide an electric insulated wire which is superior in corona discharge suppression and insulation performance and is suitable particularly for use as a coil in a motor, a transformer, or the like without sacrificing flexibility, heat resistance, and other characteristics of the insulation film (made from polyimide resin).

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. An insulation coating which is applied to an electric conductor and is baked to form an insulation film, comprising a polyimide resin having a repeating unit represented as in chemical formula (1) below, 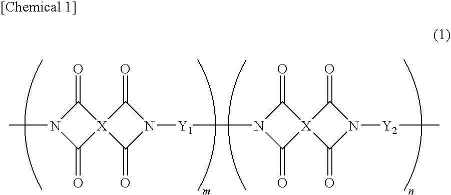
wherein: X in chemical formula (1) is a quadrivalent aromatic group having an aromatic ether structure represented as in the following chemical formula; 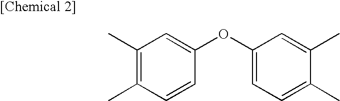
Y₁ in chemical formula (1) above is a bivalent aromatic group having an aromatic ether structure represented as in the following chemical formula; 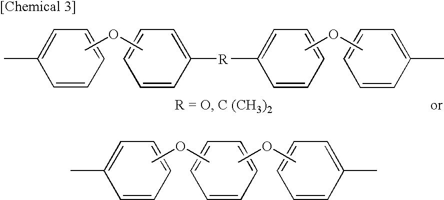
Y₂ in chemical formula (1) above is a bivalent aromatic group having a fluorene structure represented as in the following chemical formula; and 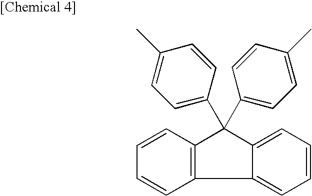
a compound ratio (Y₁/Y₂) between Y₁ and Y₂ in chemical formula (1) above is within a range from 30/70 to 80/20, when represented as a mole ratio.

2. The insulation coating according to claim 1, wherein: a ratio (m/n) between m and n in chemical formula (1) above is not smaller than 0.4 but not greater than 4.0.

3. The insulation coating according to claim 1, wherein: bivalent aromatic group Y₁ having an aromatic ether structure is one of 2,2-bis [4-(amino phenoxy)phenyl]propane, 1,3-bis (4-amino phenoxy)benzene, and 1,4-bis (4-amino phenoxy)benzene, and bivalent aromatic group Y₂ having a fluorene structure is 9,9-bis-4-(aminophenyl)fluorene.

4. An electric insulated wire having an insulation film formed by applying the insulation coating according to claim 1 to an electric conductor directly or through an internal insulation film and then by baking the insulation coating.

5. The electric insulated wire according to claim 4, wherein: the internal insulation film is formed by applying a silane coupling agent to the electric conductor and then by baking the silane coupling agent.
